(19) United States
(12) Patent Application Publication
(10) Pub. No.: US 2009/0029756 A1
(43) Pub. Date: Jan. 29, 2009

(54) MULTIMEDIA POKER TABLE AND ASSOCIATED METHODS

(76) Inventor: Frederick Guest, New York, NY (US)

Correspondence Address: GEORGE R. REARDON, 3356 STATION COURT, LAWRENCVILLE, GA, 30044, US

(21) Appl. No.: 12/177,753

(22) Filed: Jul. 22, 2008

Related U.S. Application Data
(60) Provisional application No. 60/951,360, filed on Jul. 23, 2007.

(51) Int. Cl. A63F 1/00; A63F 13/00

(52) U.S. Cl. 463/13; 273/304; 273/309; 273/148 B; 463/47; 273/460; 273/292

(57) ABSTRACT

The technology described herein provides a multimedia poker table and a deck of playing cards having machine readable indicia for use in teaching a player to improve card playing skills and reviewing the entirety of a previously played game including collected and analyzed video, audio, cards, wagers, and odds of winning information.

### CROSS-REFERENCE TO RELATED APPLICATION(S)

The present non-provisional patent application claims the benefit of priority of U.S. Provisional Patent Application No. 60/951,360, which is entitled “PLAYING CARD SCANNING SYSTEM”, which was filed on Jul. 23, 2007, and which is incorporated in full by reference herein.

### FIELD OF THE INVENTION

The technology described herein relates generally to the field of multiplayer games such as poker, and the like. More specifically, this technology relates to training and recording systems for multiplayer games.

### BACKGROUND OF THE INVENTION

There are numerous methodologies for teaching card players how to improve their play at poker. Current teaching methods include books, practice or “fake money” play, live or recorded lectures, and live or recorded demonstrations of play. None of the current methodologies allow for the accurate review and analysis of a student's actual game play in a real tournament or at a cash table in a live casino, including access to the true face values of all competing player's hands.

### BRIEF SUMMARY OF THE INVENTION

In various exemplary embodiments, the technology described herein provides a multimedia poker table and a deck of playing cards having machine readable indicia for use in teaching a player to improve card playing skills and reviewing the entirety of a previously played game including video, audio, card, wagers, and odds of winning information.

In one exemplary embodiment, the technology described herein provides a deck of playing cards, each card having a back side and a front side. The deck of playing cards includes a first unique machine readable indicium disposed upon the front side of each of the cards in the deck of playing cards. The deck of playing cards includes a second unique machine readable indicium disposed upon the back side of each of the cards in the deck of playing cards, wherein, on the same card, the first unique machine readable indicium and the second unique machine readable indicium match, such that the card is readable and identifiable from both the front side and the back side. The deck of playing cards includes fifty two cards divided into four suits of thirteen ranks of cards for playing poker. Each of the first unique machine readable indicium and each of the second unique machine readable indicium are indicative of the suit and rank of one of the fifty two cards. All fifty two cards are machine readable from both a face up and a face down card position. Each of the first unique machine readable indicium and each of the second unique machine readable indicium are varied in such a manner as to be machine readable yet indistinguishable to a naked eye of a player.

In another exemplary embodiment, the technology described herein provides a multimedia poker table. The multimedia poker table includes a deck of playing cards having machine readable indicia with at least one machine readable indicium on each card, a card playing table having a plurality of player positions and a dealer position, and a plurality of player indicia reading machines, disposed upon the multimedia poker table proximate to each player and configured to read any card of the deck of playing cards. The multimedia poker table also includes a community indicia reading machine, disposed centrally upon the multimedia poker table and configured to read any card of the deck of playing cards placed in the center of the table.

The multimedia poker table also includes a plurality of video sensors disposed upon the multimedia poker table and configured collectively to capture video information of an entire game and all of the players as the game is played. The multimedia poker table also includes an apparatus to mix a plurality of captured video information feeds obtained from the plurality of video sensors and to provide a mixed video signal to a central computer.

The multimedia poker table also includes a plurality of audio sensors disposed upon the multimedia poker table and configured collectively to capture audio information of an entire game and all of the players as the game is played. The multimedia poker table also includes an apparatus to mix a plurality of captured audio information feeds obtained from the plurality of audio sensors and to provide a mixed audio signal to a central computer.

The multimedia poker table also includes a computer having a processor configured with programming to automate collection of data obtained from the plurality of player indicia reading machines, a community indicia reading machine, a plurality of video sensors, and a plurality of audio sensors disposed upon the multimedia poker table. The multimedia poker table also includes a removable, writable data storage medium upon which to write a plurality of data comprising analyzed feedback and captured information to each player about the game.

In yet another exemplary embodiment, the technology described herein provides a method for teaching card players how to improve game play. The method includes utilizing a deck of playing cards, each card having a back side and a front side, and each card having a first unique machine readable indicium disposed upon the front side and a second unique machine readable indicium disposed upon the back side, wherein all cards are machine readable from both a face up and a face down card position, utilizing a multimedia poker table having a plurality of player positions, a dealer position, a plurality of player indicia reading machines disposed upon the multimedia poker table proximate to each player and configured to read any card of the deck of playing cards, and a community indicia reading machine disposed centrally upon the multimedia poker table and configured to read any card of the deck of playing cards placed in the center of the table, and recording game play based upon the machine readable indicia on the deck of playing cards.

The method also includes utilizing a plurality of video sensors disposed upon the multimedia poker table and configured collectively to capture video information of an entire game and all of the players as the game is played, utilizing an apparatus to mix a plurality of captured video information feeds obtained from the plurality of video sensors and to provide a mixed video signal to a central computer, and recording video of game play for subsequent review.

The method also includes utilizing a plurality of audio sensors disposed upon the multimedia poker table and configured collectively to capture audio information of an entire game and all of the players as the game is played, utilizing an apparatus to mix a plurality of captured audio information feeds obtained from the plurality of audio sensors and to provide a mixed audio signal to a central computer, and recording audio of game play for subsequent review.

The method also includes utilizing a computer having a processor configured with programming to automate collection of data obtained from the plurality of player indicia reading machines, a community indicia reading machine, a plurality of video sensors, and a plurality of audio sensors disposed upon the multimedia poker table, utilizing a removable, writable data storage medium upon which to write data comprising analyzed feedback to each player about the game, and storing collected data on the removable, writable data storage medium to subsequently provide to one or more of the game players. The method also includes processing collected card data while the game is in play to calculate a probability of each player winning a given hand.

The method also includes creating a graphical representation of the collected card data and the probability of each player winning a given hand as an overlay to a corresponding split screen video image obtained from each video sensor at that point in time in game play, storing the graphical representation and split screen video image on the removable, writable data storage medium, and providing one or more players with the removable, writable data storage medium. The method also includes reviewing, by a player or a player and an instructor, the removable, writable data storage medium to gain instructional insights as to improvement of game play.

Advantageously, the technology described herein provides the ability for game players to learn from their actual game play with real money at stake, versus simulated or “fake money” game play, in which case players face less pressure and will likely make different decisions. Additionally, players are allowed access to the true face values of all competing players down cards which they would otherwise not have. Players can view each player's probability of winning the hand which is calculated and displayed. Players can analyze their own and other player's decisions in light of the down card and calculated probability information. Players can analyze their own and other player's physical appearance and behavior during a hand in light of the down card and calculated probability information. Players can observe their own and other player's wagers during a hand in light of the down card and calculated probability information. A permanent archive is provided allowing a player to derive the maximum possible learning value from the time spent at a poker table. Players can have their play analyzed by a person not present at the time of play, such as a professional poker player or instructor. Players can share their recorded play with friends or family. Thus, there are many advantages to the system and methods described herein.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective diagram of a multimedia poker table, according to an embodiment of the technology;

FIG. 2 is a perspective, close-up diagram of a camera and microphone for use with the multimedia poker table of FIG. 1, according to an embodiment of the invention;

FIG. 3 is a top planar view of a playing card illustrating, in particular, a machine readable indicia on the front of the playing card, according to an embodiment of the technology;

FIG. 4 is a bottom planar view of a playing card illustrating, in particular, a machine readable indicia on the back of the playing card, according to an embodiment of the technology;

FIG. 5 is a top planar view of an indicia reading machine illustrating, in particular, a scanned card being read by the indicia reading machine, according to an embodiment of the technology, and;

FIG. 6 is a top planar view of the community cards in the middle of the multimedia poker table, according to an embodiment of the technology;

FIG. 7 is a top planar view of the multimedia poker table illustrating, in particular, the seating arrangement for players and a dealer, a multiplicity of recording cameras, and a multiplicity of indicia reading machines, one for each player, according to an embodiment of the technology;

FIG. 8 is a schematic view of a video image depicting the players and a graphical representation of the face values of the down cards for each player, according to an embodiment of the technology; and

FIG. 9 is a perspective diagram of the multimedia poker table of FIG. 1 also illustrating a computer and DVD recorder, according to an embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a multimedia poker table and a deck of playing cards having machine readable indicia for use in teaching a player to improve card playing skills and reviewing the entirety of a previously played game including video, audio, card, wagers, and odds of winning information.

The purpose of the technology described herein is to allow any poker player to walk into a Las Vegas style casino, play poker at a “cash” table or enter a tournament, and if he or she so chooses at the completion of play to order a DVD recording of the entirety of the game. The recording will allow the player to: see and hear himself or herself or any other player at the table at any given moment, view the true face values of all competing player's “down cards” as well as the community cards, observe the amount of money wagered, and view each player's computer calculated probability of winning the hand.

By way of example, the procedure can include the following: a player takes a seat at a specialized poker table that is located inside a typical Las Vegas style casino. The specialized poker table appears almost identical to a standard poker table except for the presence of some unobtrusive electronics. The player plays poker in the exact manner in which he or she would be accustomed to playing at a standard poker table, with the sole exception that in every hand the player must ensure that each of their down cards are successfully scanned before they are discarded. Once the player has finished playing and left the table, either by choice by elimination from a tournament, the player may choose to purchase a DVD recording of the entirety of the game play. The player may then watch the DVD and analyze his or her actual game play, or pay to have the play professionally analyzed.

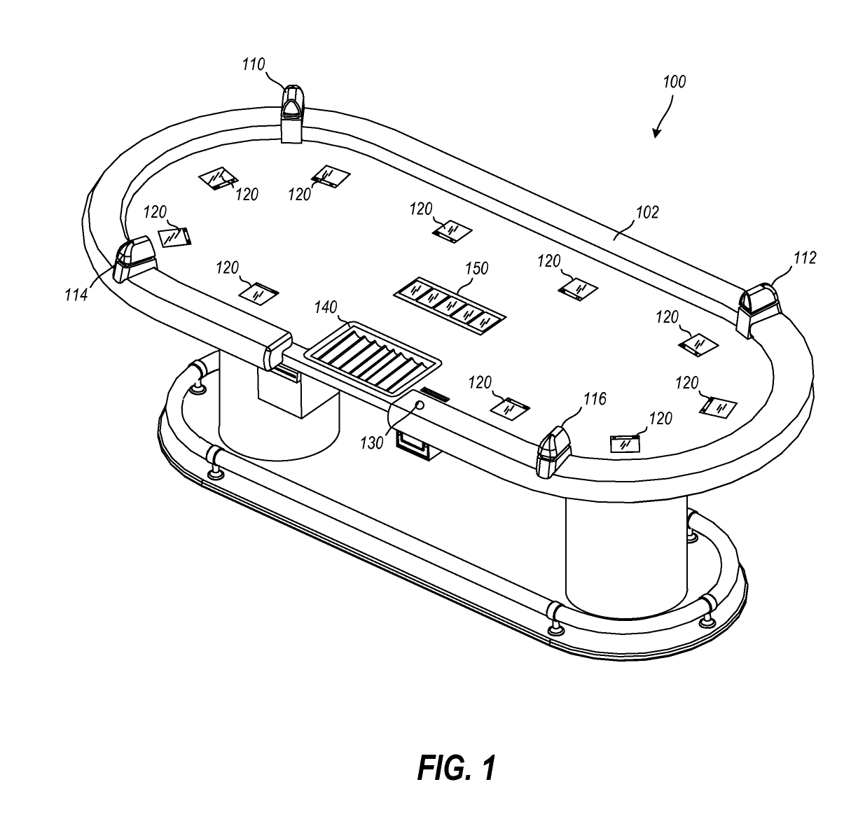

Referring now to FIG. 1, a perspective diagram of a multimedia poker table 100 is shown. The multimedia poker table 100 includes a plurality of video sensors 110, 112, 114, 116 disposed upon the multimedia poker table 100, such as on the outer perimeter 102, for example, and configured collectively to capture video information of an entire game and all of the players as the game is played out. It will be apparent to those in the art that greater or fewer video sensors 110, 112, 114, 116 can be utilized. Additionally, the video sensors 110, 112, 114, 116 can be varied in their location on or about the multimedia poker table 100 such that all players and their respective cards can be recorded. This technology provides that the video capture obtained from all video sensors 110, 112, 114, 116 can occur simultaneously, such that all players are recorded for the entirety of a game.

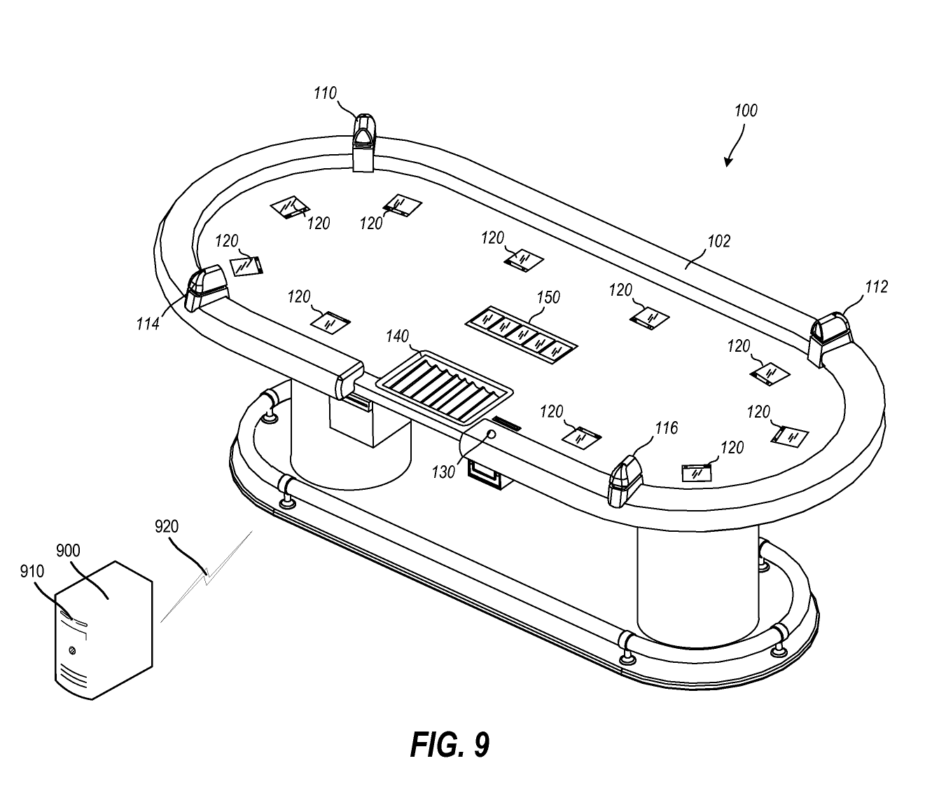

The collected video information is stored in a computer (900 in FIG. 9), either located at the multimedia poker table 100 or at a central location such as at a casino office or cage. The data can be communicated to the computer 900 through a network and can be communicated wirelessly. Additionally, an apparatus (integral with computer 900 in FIG. 9) is provided to mix a plurality of captured video information feeds obtained from the plurality of video sensors 110, 112, 114, 116 and to provide a mixed video signal to a central computer. The apparatus is, for example, a video multiplexer.

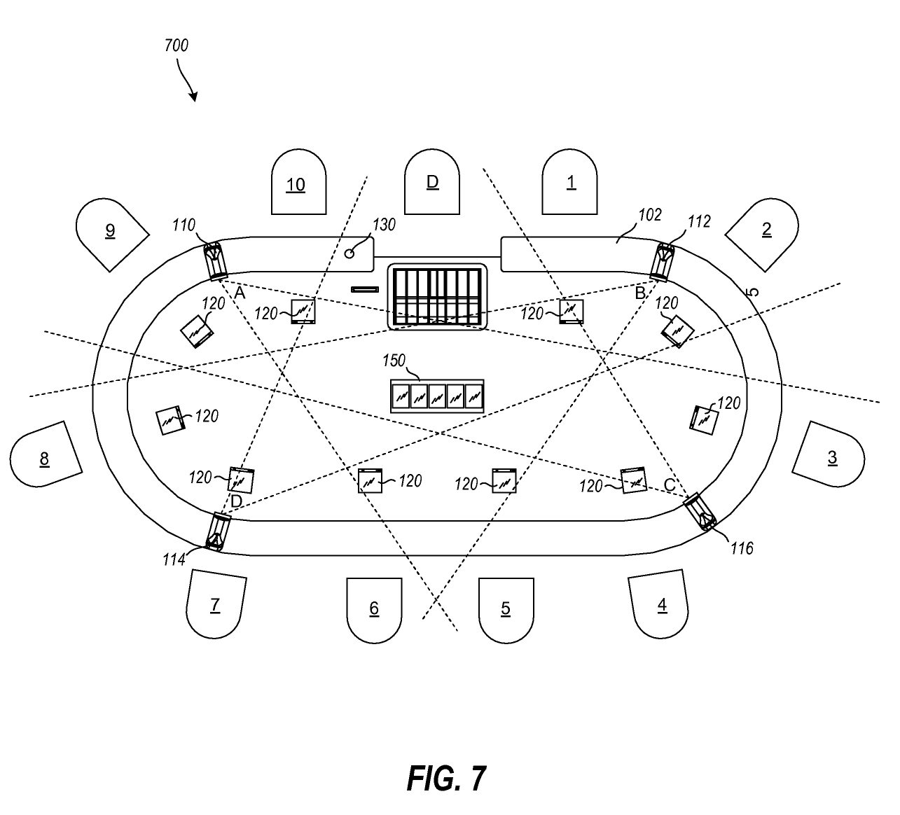

The multimedia poker table 100 is configured for ten players, but a greater or lesser number can be accommodated by reconfiguration of the table. The multimedia poker table 100 includes positions 1 through 10 (as shown in FIG. 7) at which the players are seated. Additionally, position D is available for the non-playing dealer (as shown in FIG. 7).

Each player position 1 through 10 is provided with a player card indicia reading machine 120, disposed upon the multimedia poker table 100 proximate to each player 1 through 10 and configured to read any card of the deck of playing cards throughout the game. The player card indicia reading machine 120 is utilized, for example, to read and identify, for the computer collecting such information, the down cards dealt to the player at that position. The player card indicia reading machine 120 is configured to read any and all cards from a deck of playing cards having machine readable indicia.

The multimedia poker table 100 includes a community indicia reading machine 150, disposed centrally upon the multimedia poker table 100 and configured to read any card of the deck of playing cards placed in the center of the table. This provides identification of the down cards to the computer. The community indicia reading machine 150 is electronically communicative with a computer at the multimedia poker table 100 or in a central casino location, for example. All community cards, face up and face down, will be read and identified by the community indicia reading machine 150 and the plurality of video sensors 110, 112, 114, 116 disposed upon the multimedia poker table 100.

A power source (not shown) is provided for each player card indicia reading machine 120 and each community indicia reading machine 150. The power source can be local to each machine, such as, for example but not limited to, a direct current (DC) power source. Alternatively, each player card indicia reading machine 120 and each community indicia reading machine 150 can be centrally powered through a common power source. Switch 130 is utilized to activate the game for recordation and activate power.

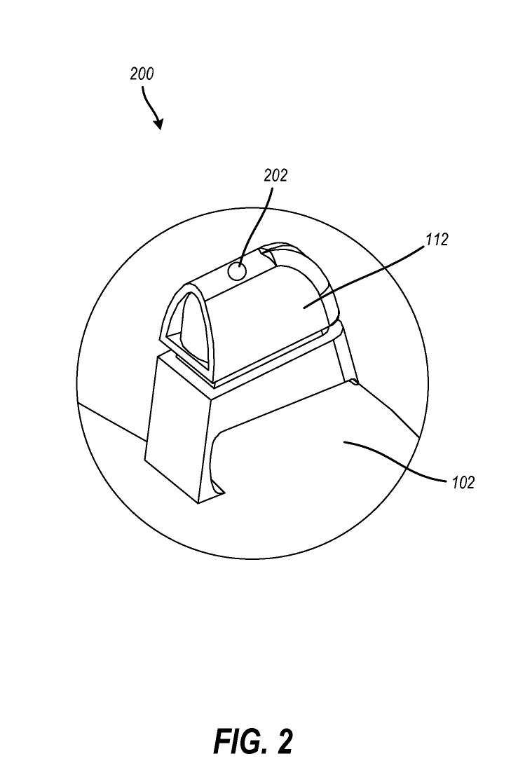

The multimedia poker table 100 includes switch 130 to control activation of the recordation of the game while it is being played. Switch 130 is electronically communicative with the plurality of video sensors 110, 112, 114, 116 disposed upon the multimedia poker table 100 and with the audio sensors 202 (FIG. 2). The switch 130 can be placed on the multimedia poker table 100 proximate to the dealer position D. Additionally, proximate to the dealer is a chip tray 140 to store chips used in game play.

Referring now to FIG. 2 a perspective, close-up diagram 200 of a camera 112 and microphone 202 are shown. The multimedia poker table 100 includes a plurality of audio sensors 202 disposed upon the multimedia poker table 100 and configured collectively to capture audio information of an entire game and all of the players as the game is played. The data can be communicated to the computer through a network and can be communicated wirelessly.

As shown, an audio sensor 202 is disposed upon each camera, camera 112, for example. However, it will be apparent to those in the art that that each audio sensor 202 can be disposed at alternative locations on, or proximate to, the multimedia poker table 100 so long as the entirety of the game is recorded in audio. Also provided is an apparatus (not shown) to mix a plurality of captured audio information feeds obtained from the plurality of audio sensors 202 and to provide a mixed audio signal to the computer, located at the multimedia poker table 100, at a central casino location, such as a cage, or elsewhere, such that all audio is mixed into one audio signal for later use in reviewing the game.

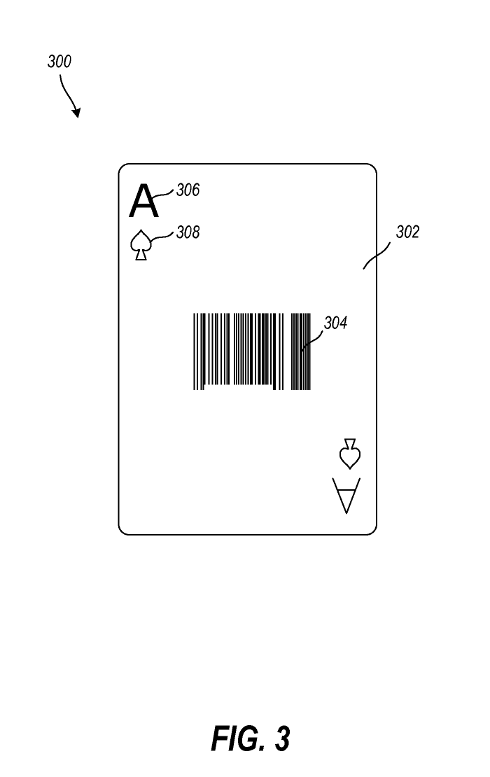

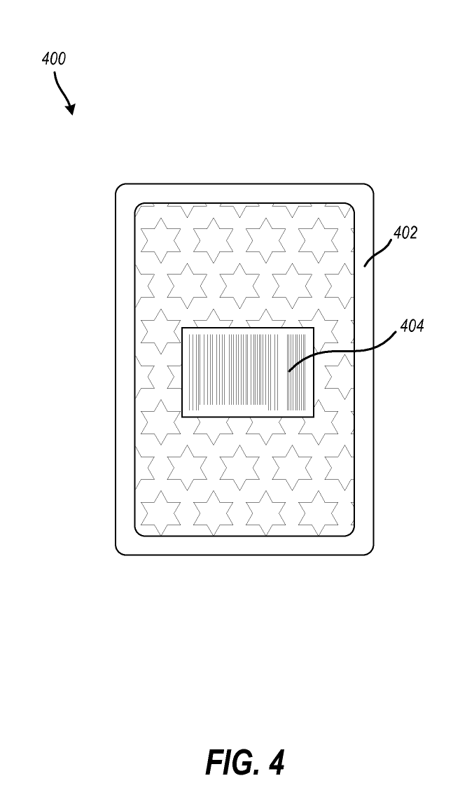

The multimedia poker table 100 includes a specialized deck of playing cards (as shown in FIGS. 3 and 4). The deck of playing cards has machine readable indicia with at least one machine readable indicium on each card. For example, the deck can include fifty two cards divided into four suits of thirteen ranks of cards for playing poker. The deck can include machine readable indicia on each side of the playing card, both the front/face side and the back side, such that each card is readable and identifiable from each side whether the card is face up or face down. By way of example, the machine readable indicia can be a barcode, or other indicia format suitable to identify a card to a machine as apparent to those in the art.

Referring now to FIG. 3 a top planar view 300 of a playing card is shown. A front, or face, surface 302 of the playing card is shown having a machine readable indicium 304. The machine readable indicium 304 is configured to identify a card by rank 306, such as A, or Ace, and by suit 308, such as spades.

Referring now to FIG. 4, a bottom planar view 400 of a playing card is shown. A back surface 402 of the playing card is shown having a machine readable indicium 404. Although rank 306 and suit 308 information (FIG. 3) is not visible on the back surface 402 of the playing card, the machine readable indicium 404 can identity the rank 306 and suit 308 of each card, such as a down card, even though a player is able to do so.

Regardless of whether on a front surface 302 or a back surface 402 of a playing card, the unique machine readable indicium paired to each card is varied in such a manner as to be machine readable yet indistinguishable to a naked eye of a player. For example, when the machine readable indicia are barcodes, the barcode contains information that uniquely identifies that card by suit and rank. Because the barcodes are printed on the back of the cards, there is a risk that players may recognize patterns in the lines of the barcodes and identify the cards of the other players at the table even when they are facing down by looking at the bar codes on the back of the cards.

This perceived risk is eliminated with the technology described herein. Because there are only 52 cards in the deck, each card only requires to two characters of data to be uniquely identified. For example if the cards were numbered “01” through “52”. A barcode, for example, can hold many more than two characters of data. For these playing cards, if each barcode were to contain 100 characters of data for example, 98 of those characters would be exactly the same and in the exact same order for each card, and two characters of data would be different on each card in order to identify them uniquely. Therefore, because 98% of the data in the barcode would be exactly the same for each card, the barcodes would look almost perfectly identical and be indistinguishable to the naked eye, thus eliminating this perceived risk from the game.

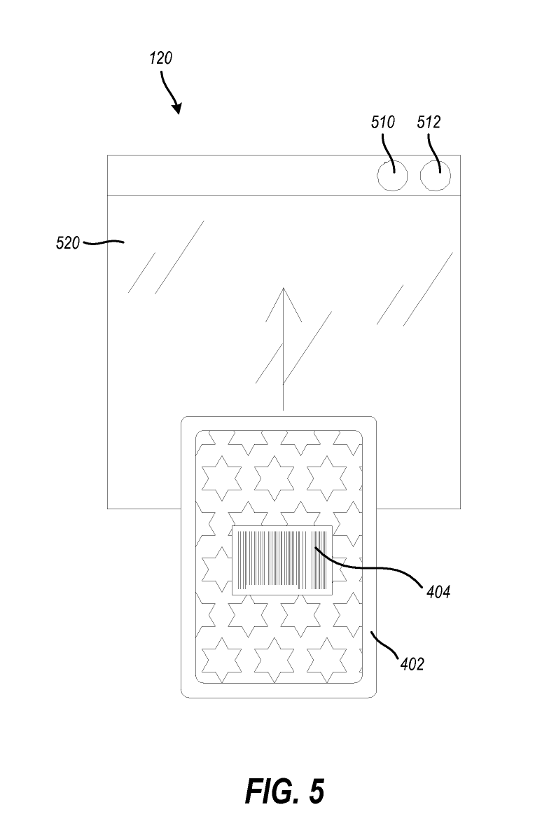

Referring now to FIG. 5, a top planar view of an indicia reading machine 120 is shown. An indicia reading machine 120 is proximate to each player at the multimedia poker table 100. The indicia reading machine 120 includes surface 520 over which, or near which, a playing card is placed to be read and identified for recordation of the entire game. Every card read is recorded.

The indicia reading machine 120 includes two indicator lights 510, 512 to illuminate one-at-a-time as a card is scanned. The indicator lights 510, 512 illuminate one at a time as the cards are scanned to indicate that two unique barcodes have been read. As will be apparent to those in the art, alternative embodiments can include variation in the application of the indicator lights 510, 512 so long as the cards are read and identified correctly. For example, the indicia reading machine 120 can be utilized with only one indicator light.

By way of example, as a face-down card is placed near the indicia reading machine 120 over surface 520, the back surface 402 having machine readable indicia 404, the indicia reading machine 120 reads and identifies the card, even though the face-side of the card is not visible to players. All card readings are collected and stored in the computer and made available for subsequent game review for instructional or other purposes.

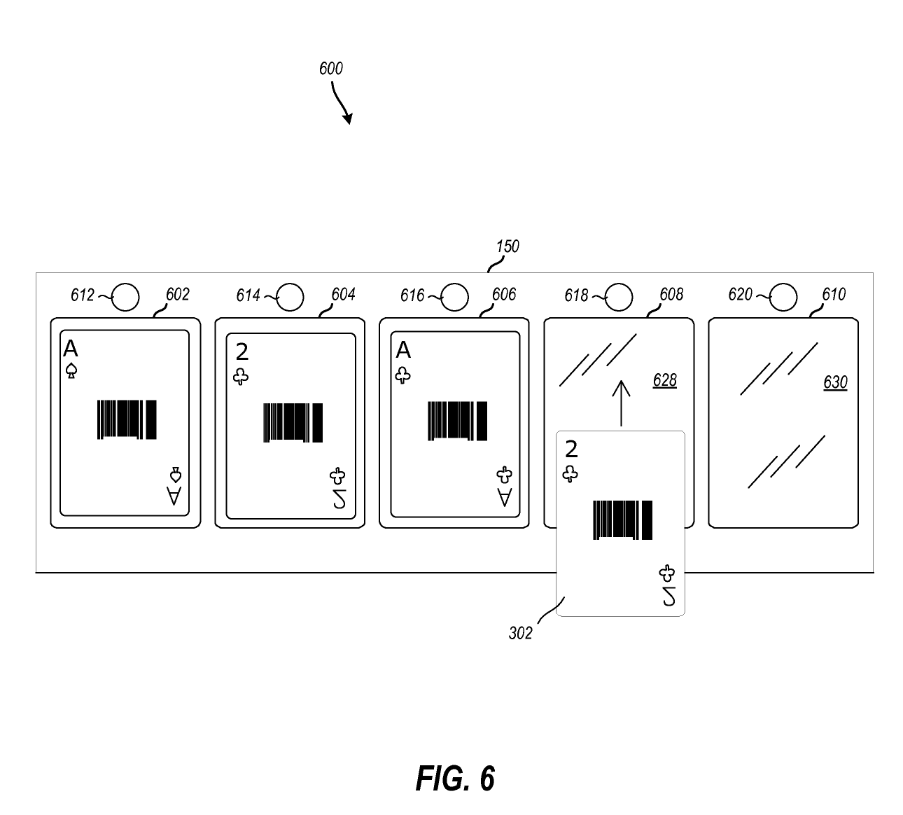

Referring now to FIG. 6, a top planar view 600 of the community cards and community indicia reading machine 150 is shown. There are five indicator lights 612, 614, 616, 618, 620 above the community indicia reading machine 150 in the center of the table that illuminate one at a time to indicate that five unique indicium on cards 602, 604, 606, 608, 610 have been read. As top surface 302 of a card, for example, is placed near surface 628, indicator light 618 will illuminate. By way of example, all indicator lights 612, 614, 616, 618, 620 are connected to a single control switch 130 at position D. The dealer will be required to press the switch 130 at the conclusion of each hand to reset the indicator lights 612, 614, 616, 618, 620.

Referring now to FIG. 7, a top planar view 700 of the multimedia poker table 100 is shown. The multimedia poker table 100 is configured for ten players, but a greater or lesser number can be accommodated by reconfiguration of the table. The multimedia poker table 100 includes positions 1 through 10 at which the players are seated. Additionally, position D is available for the non-playing dealer.

The multimedia poker table 100 includes a plurality of video sensors 110, 112, 114, 116 disposed upon the multimedia poker table 100, such as on the outer perimeter 102, for example, and configured collectively to capture video information of an entire game and all of the players as the game is played out. This technology provides that the video capture obtained from all video sensors 110, 112, 114, 116 can occur simultaneously, such that all players are recorded for the entirety of a game.

By way of example, video sensor, or camera 110, observes angle A and includes a view of players 3, 4, 5; camera 112 observes angle B and includes a view of players 6, 7, 8; camera 114 observes angle D and includes a view of the dealer D and players 1 and 2; and camera 116 observes angle C and includes a view of players 9 and 10 and the dealer D. Varied camera arrangements can be utilized provided all game play and video or players and dealers is recorded.

The collected video information is stored in a computer, either located at the multimedia poker table 100 or at a central location such as at a casino office or cage. Additionally, an apparatus is provided to mix a plurality of captured video information feeds obtained from the plurality of video sensors 110, 112, 114, 116 and to provide a mixed video signal to a central computer. The apparatus is, for example, a video multiplexer. Recorded video is multiplexed into a single video signal for recordation, for example, to a DVD for purchase and review by a player.

Each player position 1 through 10 is provided with a player card indicia reading machine 120, disposed upon the multimedia poker table 100 proximate to each player 1 through 10 and configured to read any card of the deck of playing cards throughout the game. The player card indicia reading machine 120 is utilized, for example, to read and identify, for the computer collecting such information, the down cards dealt to the player at that position. The player card indicia reading machine 120 is configured to read any and all cards from a deck of playing cards having machine readable indicia.

The multimedia poker table 100 includes a community indicia reading machine 150, disposed centrally upon the multimedia poker table 100 and configured to read any card of the deck of playing cards placed in the center of the table. This provides identification of the down cards to the computer. The community indicia reading machine 150 is electronically communicative with a computer at the multimedia poker table 100 or in a central casino location, for example. All community cards, both face up and face down, will be read and identified by the community indicia reading machine 150 and the plurality of video sensors 110, 112, 114, 116 disposed upon the multimedia poker table 100.

A power source (not shown) is provided for each player card indicia reading machine 120 and each community indicia reading machine 150. The power source may be local to each machine, such as, for example but not limited to, a direct current (DC) power source. Alternatively, each player card indicia reading machine 120 and each community indicia reading machine 150 can be centrally powered through a common power source. Switch 130 is utilized to activate the game for recordation and activate power.

The multimedia poker table 100 includes switch 130 to control activation of the recordation of the game while it is being played. Switch 130 is electronically communicative with the plurality of video sensors 110, 112, 114, 116 disposed upon the multimedia poker table 100 and with the audio sensors 202 (FIG. 2). The switch 130 can be placed on the multimedia poker table 100 proximate to the dealer position D. Additionally, proximate to the dealer is a chip tray 140 to store chips used in game play.

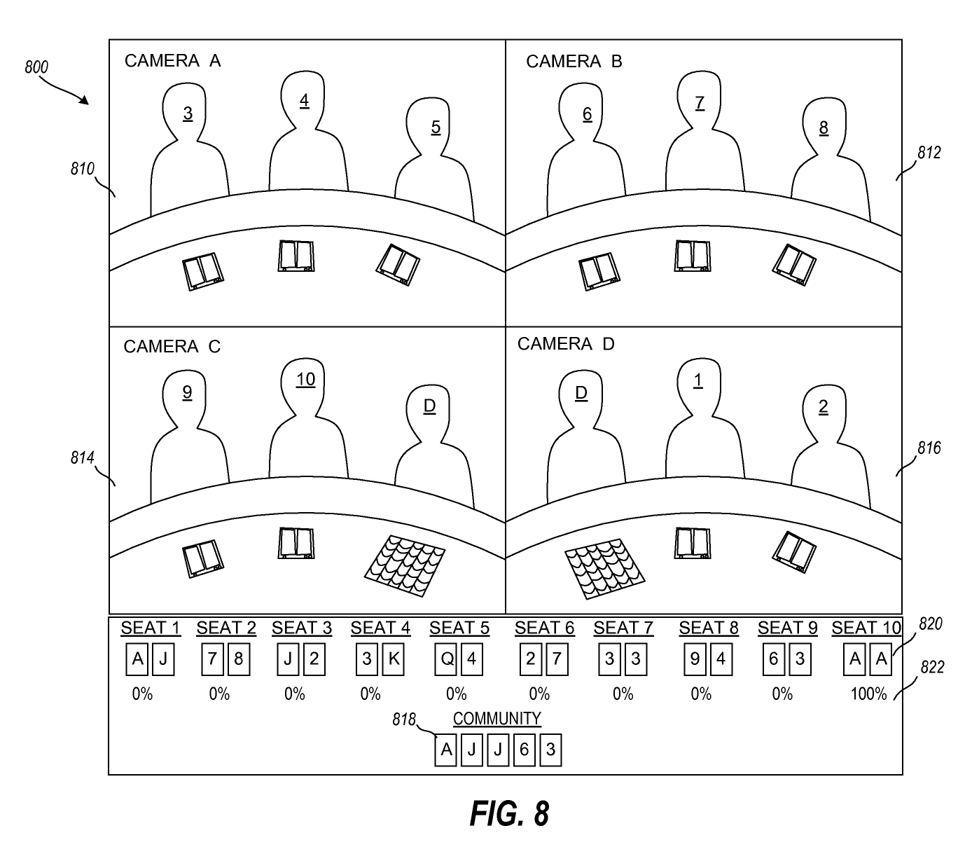

Referring now to FIG. 8, a schematic 800 of a still-view video image depicting the players and a graphical representation of the face values of the down cards for each player is shown. This technology provides for the continuous recording of video, audio, card identification, odds of winning a hand, card plays, and the like. Schematic 800 is a single still-view video image of such a recording.

A combined visual display is shown illustrating, for example, the video feeds from four video feeds from video sensors 110, 112, 114, 116, having camera angles A, B, D, and C, respectively. The view from camera angle A image 810 is shown. The view from camera angle B image 812 is shown. The view from camera angle C image 814 is shown. The view from camera angle D image 816 is shown.

The still-view video image in schematic 800 includes identification of the down cards 820 of players in each seat. This is useful when reviewing a game to gain instructional aspects. The still-view video image in schematic 800 includes identification of the community cards 818, whether face-up or face-down. Additionally, the still-view video image in schematic 800 includes the probability 822 for each player to win the given hand. Therefore, is review of a game, a player is instructed as to odds of winning each hand and can compare that with plays he or she made and that of the opponent players. Other aspects of the game, such as other data recorded by the video and audio sensors, can be displayed in the still-view video image in schematic 800.

All video and audio data, as well as all card data, is communicated to the computer. The computer converts the machine readable indicia data from the cards into a graphical representation of the down cards of each player as well as the community cards. The computer calculates the probability of each player winning the hand based on the down card information and community card information provided by the barcode scanners. The computer overlays a graphical representation of the community cards, each players down cards, and each player's probability of winning onto the split screen image of the appropriate round of play. The computer mixes the machine readable indicia data from the cards, video, and audio data into a single multimedia file. The computer allows DVDs of the final multimedia content to be burned for any time period, subject to the capacity limitations of the DVD.

Referring now to FIG. 9, a perspective diagram of the multimedia poker table 100 of FIG. 1 is shown, also illustrating a computer 900 and DVD recorder 910. Computer 900 is electronically communicative through path 920 to the multimedia poker table 100. This electronic communication can be tethered or wireless. The video and audio multiplexers can be integral to the computer 900.

By way of example, in one embodiment the technology described herein includes the following steps regarding table flow and DVD acquisition, if the computer were located below the table: 1) a player sits at the multimedia poker table, 2) the player is dealt first card face down, 3) the player slides first card over the indicia reader in front of his seat position until the first indicator light illuminates, 4) the player is dealt second card face down (this event is not dependent on event 3), 5) the player slides second card over the indicia reader in front of his seat position until the second indicator light illuminates, 6) the player looks at both down cards (not dependent on 3 or 5), 7) player determines if he or she will fold, call, or raise the bet (folding is dependent on 3 and 5), 8) the dealer deals “the flop” (this is dependent on every player completing 3 and 5), 9) the round of poker is completed exactly as it would be at a standard poker table, 10) when the player decides he or she has played long enough, the chips (if any) are collected and indication is made to dealer of interest to buy a DVD of the game, 11) the player must tell the dealer a start and stop time for the DVD (if the start and stop times exceed 3 hours—or whatever the capacity limitation of the DVDs turns out to be—then the player would have to pay for multiple DVDs), 12) the player pays the dealer in chips or cash (the player may now leave the table), 13) the dealer puts the chips or cash into a separate drop box for DVD revenue (standard poker tables use this revenue collection format for the “rake”—the DVD revenue would require an additional drop box so as to be separate from the rake), 14) the dealer inserts a blank DVD into the drive, 15) the dealer enters the start and stop times into an interface to the computer and starts the DVD burning (target time should be 30 seconds or less for this step; the system should default to the max available time on the DVD so the dealer only has to enter the start time), 16) when the DVD has finished burning the dealer calls over a floor attendant who will collect the DVD and bring it to the “cage” where it will be left in the players name to be collected at their convenience. It is important that the player pays for the DVD before they leave the table b/c otherwise they may not return to collect it. Steps 10 through 16 do not require the play to stop for the rest of the players. There are natural pauses during a hand at which time the various steps can be carried out. The “rake” is a small cut of each pot (2%-3%) that the casino takes for itself. The “cage” is the area where all the cashiers are located where players can buy chips or cash chips out. It will be readily apparent to those of ordinary skill in the art that other embodiments and examples can perform similar functions and/or achieve like results.

By way of example, in an alternative embodiment the technology described herein includes the following steps regarding table flow and DVD acquisition, if the computer were located at the cashier: 1) steps 1 through 9 are exactly the same as in the embodiment immediately above, 2) when the player decides he has played long enough he collect his chips (if any) and leaves the table, 3) the player walks over to the cage (which he would have to do anyway to cash out any chips they have) and indicates to one of the attendants that has been assigned the additional duty of burning DVDs that he would like to buy a DVD, 4) the player must tell the attendant which table number he was at and a start and stop time for the DVD (if the start and stop times exceed 3 hours—or whatever the capacity limitation of the DVDs turns out to be—then the player would have to pay for multiple DVDs), 5) the player pays the attendant with cash, chips or credit card, 6) the player is now free to leave and return after the minimum time necessary for the DVD(s) to burn has passed, 7) the attendant inserts a blank DVD into the drive (if there a multiple computers to serve multiple tables then the attendant obviously must insert the DVD into the drive of the appropriate computer), and 8) the attendant enters the start and stop times into an interface to a computer and starts the DVD burning (such as a simple touch screen interface with as few key strokes as possible; target time should be 30 seconds or less for this step; the system should default to the max available time on the DVD so the attendant only has to enter the start time). The embodiment enables the ability to accept credit card payment and also moves the DVD ordering, payment, and burning process away from the table, reducing the load on the dealer and the potential stoppages of play. It will be readily apparent to those of ordinary skill in the art that other embodiments and examples can perform similar functions and/or achieve like results.

Although this technology has been illustrated and described herein with reference to preferred embodiments and specific examples thereof, it will be readily apparent to those of ordinary skill in the art that other embodiments and examples can perform similar functions and/or achieve like results. For example, this game and its associated methods can be embodied in an electronic format, played on a personal computer, the Internet, or the like. All such equivalent embodiments and examples are within the spirit and scope of the invention and are intended to be covered by the following claims.

What is claimed is:

1. A deck of playing cards, each card having a back side and a front side, the deck of playing cards comprising:
a first unique machine readable indicium disposed upon the front side of each of the cards in the deck of playing cards.

2. The deck of playing cards of claim 1, further comprising:
a second unique machine readable indicium disposed upon the back side of each of the cards in the deck of playing cards, wherein, on the same card, the first unique machine readable indicium and the second unique machine readable indicium match, such that the card is readable and identifiable from both the front side and the back side.

3. The deck of playing cards of claim 2,
wherein the deck of playing cards comprises fifty two cards divided into four suits of thirteen ranks of cards for playing poker;
wherein each of the first unique machine readable indicium and each of the second unique machine readable indicium are indicative of the suit and rank of one of the fifty two cards; and
wherein all fifty two cards are machine readable from both a face up and a face down card position.

4. The deck of playing cards of claim 2,
wherein each of the first unique machine readable indicium and each of the second unique machine readable indicium are varied in such a manner as to be machine readable yet indistinguishable to a naked eye of a player.

5. A multimedia poker table comprising:
a deck of playing cards having machine readable indicia with at least one machine readable indicium on each card;
a card playing table having a plurality of player positions and a dealer position; and
a plurality of player indicia reading machines, disposed upon the multimedia poker table proximate to each player and configured to read any card of the deck of playing cards.

6. The multimedia poker table of claim 5, further comprising:
a community indicia reading machine, disposed centrally upon the multimedia poker table and configured to read any card of the deck of playing cards placed in the center of the table.

7. The multimedia poker table of claim 6, further comprising:
a plurality of video sensors disposed upon the multimedia poker table and configured collectively to capture video information of an entire game and all of the players as the game is played.

8. The multimedia poker table of claim 7, further comprising:
an apparatus to mix a plurality of captured video information feeds obtained from the plurality of video sensors and to provide a mixed video signal to a central computer.

9. The multimedia poker table of claim 6, further comprising:
a plurality of audio sensors disposed upon the multimedia poker table and configured collectively to capture audio information of an entire game and all of the players as the game is played.

10. The multimedia poker table of claim 9, further comprising:
an apparatus to mix a plurality of captured audio information feeds obtained from the plurality of audio sensors and to provide a mixed audio signal to a central computer.

11. The multimedia poker table of claim 5, further comprising:
a computer having a processor configured with programming to automate collection of data obtained from the plurality of player indicia reading machines, a community indicia reading machine, a plurality of video sensors, and a plurality of audio sensors disposed upon the multimedia poker table.

12. The multimedia poker table of claim 1, further comprising:
a removable, writable data storage medium upon which to write a plurality of data comprising analyzed feedback and captured information to each player about the game.

13. A method for teaching card players how to improve game play, the method comprising:
utilizing a deck of playing cards, each card having a back side and a front side, and each card having a first unique machine readable indicium disposed upon the front side and a second unique machine readable indicium disposed upon the back side, wherein all cards are machine readable from both a face up and a face down card position;
utilizing a multimedia poker table having a plurality of player positions, a dealer position, a plurality of player indicia reading machines disposed upon the multimedia poker table proximate to each player and configured to read any card of the deck of playing cards, and a community indicia reading machine disposed centrally upon the multimedia poker table and configured to read any card of the deck of playing cards placed in the center of the table; and
recording game play based upon the machine readable indicia on the deck of playing cards.

14. The method of claim 13, further comprising:
utilizing a plurality of video sensors disposed upon the multimedia poker table and configured collectively to capture video information of an entire game and all of the players as the game is played;
utilizing an apparatus to mix a plurality of captured video information feeds obtained from the plurality of video sensors and to provide a mixed video signal to a central computer; and
recording video of game play for subsequent review.

15. The method of claim 13, further comprising:
utilizing a plurality of audio sensors disposed upon the multimedia poker table and configured collectively to capture audio information of an entire game and all of the players as the game is played;
utilizing an apparatus to mix a plurality of captured audio information feeds obtained from the plurality of audio sensors and to provide a mixed audio signal to a central computer; and
recording audio of game play for subsequent review.

16. The method of claim 13, further comprising:
utilizing a computer having a processor configured with programming to automate collection of data obtained from the plurality of player indicia reading machines, a community indicia reading machine, a plurality of video sensors, and a plurality of audio sensors disposed upon the multimedia poker table;
utilizing a removable, writable data storage medium upon which to write data comprising analyzed feedback to each player about the game; and
storing collected data on the removable, writable data storage medium to subsequently provide to one or more of the game players.

17. The method of claim 16, further comprising:
processing collected card data while the game is in play to calculate a probability of each player winning a given hand.

18. The method of claim 16, further comprising:
creating a graphical representation of the collected card data and the probability of each player winning a given hand as an overlay to a corresponding split screen video image obtained from each video sensor at that point in time in game play;
storing the graphical representation and split screen video image on the removable, writable data storage medium; and
providing one or more players with the removable, writable data storage medium.

19. The method of claim 18, further comprising:
reviewing, by a player, the removable, writable data storage medium to gain instructional insights as to improvement of game play.

20. The method of claim 18, further comprising:
reviewing, by a player and an instructor, the removable, writable data storage medium to gain instructional insights as to improvement of game play.
